(19) United States
(12) Patent Application Publication
(10) Pub. No.: US 2005/0140112 A1
(43) Pub. Date: Jun. 30, 2005

(54) Rear wheel suspension apparatus

(76) Inventor: Hyuk Kim, Siheung (KR)

Correspondence Address: MORGAN, LEWIS & BOCKIUS LLP (SF), 2 PALO ALTO SQUARE, PALO ALTO, CA, 94306, US

(21) Appl. No.: 11/009,982

(22) Filed: Dec. 10, 2004

(30) Foreign Application Priority Data
Dec. 30, 2003 (KR) 2003-0100933

(51) Int. Cl. B60G 3/20

(52) U.S. Cl. 280/124.143

(57) ABSTRACT

A rear wheel suspension apparatus for a vehicle is provided, comprising: a carrier to which a wheel is mounted; a plurality of arms comprising a transverse lower arm connecting the carrier to a sub-frame, a transverse compensating arm, a transverse upper arm, and a longitudinal arm; a spring providing an elastic force; and a shock absorber. The transverse upper arm is positioned ahead of the transverse lower arm. The spring is located on the transverse lower arm. A lower fixing eye of the shock absorber is connected to the carrier at a position lower than a link point between the carrier and the transverse lower arm. An upper portion of the shock absorber is connected to a side portion of a vehicle frame.

### CROSS REFERENCE TO RELATED APPLICATIONS

This application claims priority from Korean Application No. 10-2003-0100933, filed on Dec. 30, 2003, which is incorporated herein by reference in its entirety.

### FIELD OF THE INVENTION

The present invention relates to a suspension system for a vehicle, and more particularly, to a multi-link type rear wheel suspension system for a vehicle.

### BACKGROUND OF THE INVENTION

Generally, in the conventional rear wheel suspension apparatus of a vehicle, the ends of a plurality of transverse arms are connected to a carrier to which a wheel is coupled, and the other ends of the plurality of transverse arms are connected to an auxiliary frame that extends in a transverse direction of the vehicle. One end of a longitudinal arm is connected to the carrier, and the other end of the longitudinal arm is connected to a vehicle body. In addition, a spring and shock absorber assembly, in which a spring and a shock absorber are formed integrally, is provided. A lower portion of the spring and shock absorber assembly is connected to an upper portion of the carrier, and an upper portion thereof is fixed to a wheel house.

However, in such a conventional rear wheel suspension apparatus, the shock generated by the vehicle driving on a road's surface is concentrated on the mounting strut, where a huge reactional force is generated. Therefore, the mounting strut must be designed with sufficient structural integrity.

In addition, routes for transmitting vibrations are concentrated on the mounting strut, so it is difficult to effectively block the transmission of vibrations to the passenger compartment. Furthermore, the spring and shock absorber assembly protrudes into the vehicle's interior, making it difficult to produce a flat and wide inside space in the passenger compartment and in the trunk.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

An embodiment of the present invention provides a rear wheel suspension apparatus in which a shock absorber and a spring are separately mounted, vibration characteristics are improved by regulating the geometry of transverse arms, and it becomes easier to provide a wide passenger room space and a wide trunk space.

In a preferred embodiment of the present invention, the rear wheel suspension apparatus of a vehicle comprises: a carrier to which a wheel is mounted; a plurality of arms comprising a transverse lower arm connecting the carrier to a sub-frame, a transverse compensating arm, a transverse upper arm, and a longitudinal arm; a spring providing an elastic force; and a shock absorber. The transverse upper arm is positioned ahead of the transverse lower arm. The spring is located on the transverse lower arm. A lower fixing eye of the shock absorber is connected to the carrier at a position lower than a link point between the carrier and the transverse lower arm. An upper portion of the shock absorber is connected to a side portion of a vehicle frame.

It is preferable that the upper portion of the shock absorber is connected to a slanted portion of a side portion of the vehicle frame, and that the lower fixing eye is connected to a lower portion of the carrier. Preferably, the lower fixing eye is positioned to be lower by more than 25 mm than the link point between the carrier and the transverse lower arm.

One end of the longitudinal arm is preferably connected to the carrier, and the other end of the longitudinal arm is rotatably connected to a vehicle body.

The rear wheel suspension apparatus may further comprise a stabilizer elongating in a front portion of the sub-frame. The stabilizer is fixed to the sub-frame through a guide, and both ends of the stabilizer are connected to the carrier.

Alternatively, the rear wheel suspension apparatus may further comprise a stabilizer elongating in a rear portion of the sub-frame. The stabilizer is fixed to the sub-frame through a guide, and both ends of the stabilizer are connected to the transverse lower arm.

In another embodiment of the present invention, a rear wheel suspension apparatus of a vehicle comprises: a carrier to which a wheel is mounted; a plurality of arms comprising a transverse lower arm connecting the carrier to a sub-frame, a transverse compensating arm, a transverse upper arm, and a longitudinal arm; a spring providing an elastic force; and a shock absorber. A ratio of a first distance between inner and outer link points of the transverse lower arm, and a second distance between a center point between an inner link point of the transverse upper arm and an inner link point of the transverse compensating arm and a center point between an outer link point of the transverse upper arm and an outer link point of the transverse compensating arm is determined to be approximately between 0.55 and 0.65. A ratio of a first distance between a center point of the carrier and a center point between the outer link point of the transverse lower arm and the outer link point of the transverse compensating arm, and a second distance between the center point of the carrier and the outer link point of the transverse upper arm is determined to be approximately between 0.9 and 1.1. A ratio of a first distance between a center point between the outer link point of the transverse lower arm and the outer link point of the transverse compensating arm and a center point between the inner link point of the transverse lower arm and the inner link point of the transverse compensating arm, and a second distance between the outer and inner link points of the transverse upper arm is determined to be approximately between 0.7 and 0.9. The outer link point of the transverse lower arm is positioned longitudinally ahead of the inner link of the transverse lower arm or longitudinally at the same level with the inner link point of the transverse lower arm. The outer link point of the transverse compensating arm is positioned longitudinally behind the inner link of the transverse compensating arm or longitudinally at the same level with the inner link point of the transverse compensating arm. The outer link point of the transverse lower arm is positioned not to be higher than the inner link point of the transverse lower arm. The outer link point of the transverse compensating arm is positioned not to be higher than the inner link point of the transverse compensating arm.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a perspective view of a rear wheel suspension system according to an embodiment of the present invention;

FIG. 2 is a top view of a rear wheel suspension system according to an embodiment of the present invention;

FIG. 3 is a side elevational view of a rear wheel suspension system according to an embodiment of the present invention; and

FIG. 4 is a rear view of a rear wheel suspension system according to an embodiment of the present invention.

### DETAILED DESCRIPTION OF THE PREFERRED EMBODIMENTS

Hereinafter, a preferred embodiment of the present invention will be described in detail with reference to the accompanying drawings.

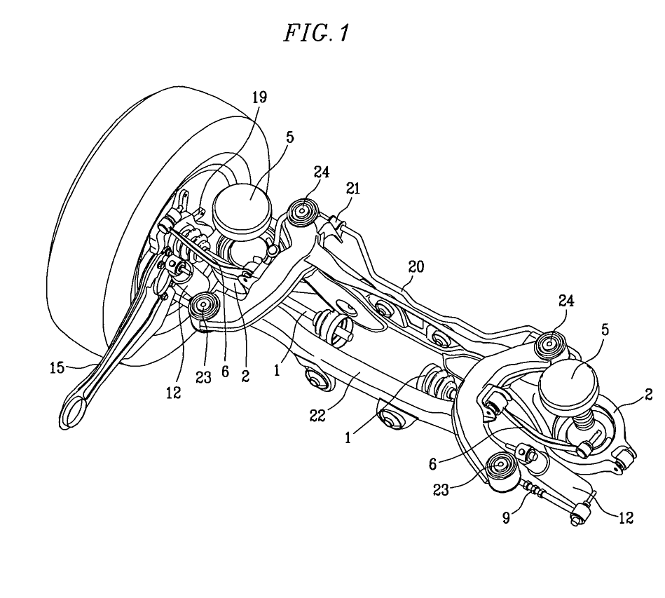

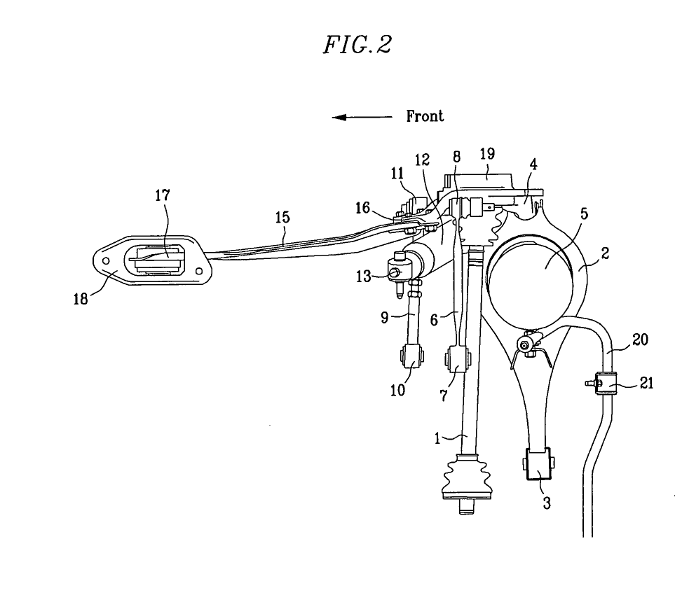

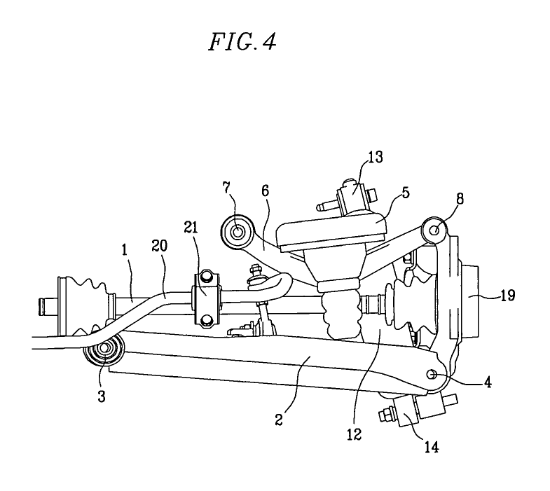

As shown in FIGS. 1 through 4, a rear wheel suspension apparatus according to an embodiment of the present invention comprises a transverse lower arm 2, a transverse compensating arm 9, a transverse upper arm 6, and a longitudinal arm 15.

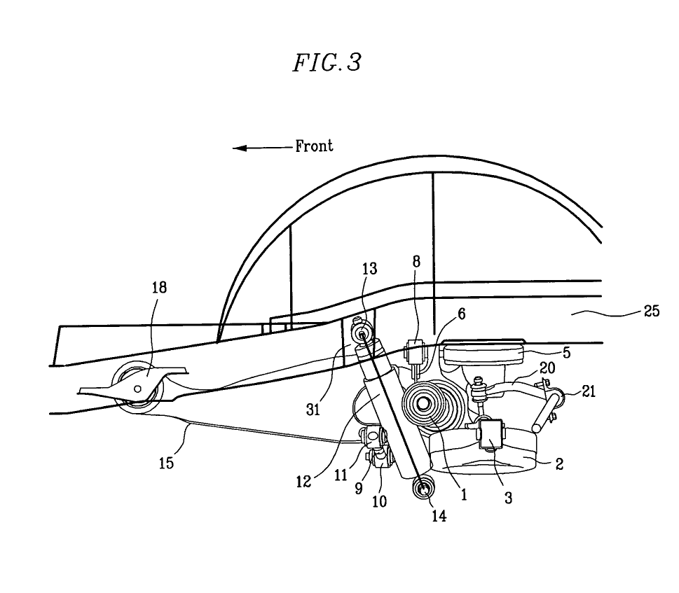

The transverse upper arm 6 is positioned ahead of the transverse lower arm 2, and one end of each of the transverse lower arm 2, the transverse compensating arm 9, and the transverse upper arm 6 are connected to a carrier 19. As shown in FIG. 3, the longitudinal arm 15 is rotatably connected to a bracket 18 that is fixed to a vehicle body. Therefore, the longitudinal arm 15 is rotatably connected to the vehicle body. The bracket 18 can be eliminated depending on the shape of the vehicle body, and it is also possible that the longitudinal arm 15 can be directly connected to the vehicle body.

The vehicle's body is supported by a spring assembly 5 and a shock absorber 12. A lower portion of the spring assembly 5 is located on the transverse lower arm 2, and an upper portion of the spring assembly 5 is received by a cap (not shown).

A lower portion of the shock absorber 12 is connected to the carrier 19. An upper portion of the shock absorber 12 is connected to a side portion of a frame 25 of the vehicle's body through a bolt and a nut or a bracket.

The lower portion of the shock absorber 12 can be connected to a lower portion of the carrier 19. A lower fixing eye 14 of the shock absorber 12 is positioned to be lower than a link point 4 between the carrier 19 and the transverse lower arm 2.

By connecting the upper portion of the shock absorber 12 to the side portion of the frame 25 and connecting the lower portion of the shock absorber 12 to the lower portion of the carrier 19, the shock absorber 12 can be prevented from protruding into an upper portion of a housing so that the size of the housing can be decreased.

In particular, as shown in FIG. 3, one embodiment provides a slanted portion 31 that slants downward from a side portion of the frame 25. By connecting an upper eye 13 of the shock absorber 12 to the slanted portion 31 and connecting the lower eye 14 of the shock absorber 12 to the lower portion of the carrier 19, the lower eye 14 of the shock absorber 12 is positioned to be lower by more than 25 mm than a connecting point of the carrier 19 and the transverse lower arm 2. Therefore, it is possible to secure a wide passenger room.

The transverse lower arm 2, the transverse upper arm 6, and the transverse compensating arm 9 are connected to a sub-frame 22 that elongates along the width of the vehicle. Both ends of a stabilizer 20 elongate along a rear portion of the vehicle and are connected to the transverse lower arm 2. In addition, the stabilizer 20 is fixed to the sub-frame 22 through a guide 21. When both ends of the stabilizer 20 elongate in a front portion of the sub-frame 22, both ends of the stabilizer 20 can be connected to the carrier 19.

Positions of the transverse arms 2, 6, and 9 will be explained in detail hereinbelow. A ratio (a/b) of a distance (b) between inner and outer link points 3, 4 of the transverse lower arm 2, and a distance (a) between a center point between an inner link point 7 of the transverse upper arm 6 and an inner link point 10 of the transverse compensating arm 9 and a center point between an outer link point 8 of the transverse upper arm 6 and an outer link point 11 of the transverse compensating arm 9 is preferably determined to be approximately between 0.55 and 0.65.

In addition, the outer link point 4 of the transverse lower arm 2 is preferably positioned longitudinally ahead of the inner link point 3 or longitudinally at the same level with the inner link point 3, and the outer link point 11 of the transverse compensating arm 9 is preferably positioned longitudinally behind the inner link point 10 or longitudinally at the same level with the inner link point 10.

A ratio (c/d) of a distance (d) between a center point of the carrier 19 and a center point between the outer link point 4 of the transverse lower arm 2 and the outer link point 11 of the transverse compensating arm 9, and a distance (c) between the center point of the carrier 19 and the outer link point 8 of the transverse upper arm 6 is preferably determined to be approximately between 0.9 and 1.1.

A ratio (e/f) of a distance (f) between a center point between the outer link point 4 of the transverse lower arm 2 and the outer link point 11 of the transverse compensating arm 9 and a center point between the inner link point 3 of the transverse lower arm 2 and the inner link point 10 of the transverse compensating arm 9, and a distance (e) between the outer and inner link points 8 and 7 of the transverse upper arm 6 is preferably determined to be approximately between 0.7 and 0.9.

The outer link point 4 of the transverse lower arm 2 is positioned not to be higher than the inner link point 3 thereof, and the outer link point 11 of the transverse compensating arm 9 is positioned not to be higher than the inner link point 10 thereof.

By optimizing a geometry for the rear wheel suspension, linear stability that is impervious to outer disturbances, e.g., as changes in driving states such as toe characteristics in bumping, rolling, braking, and accelerating, can be secured, and cornering stability is simultaneously secured by setting lateral force steering characteristics to form a suitable toe-in cornering such that optimal under-steering can be produced during cornering. In addition, in the rear wheel suspension apparatus according to an embodiment of the present invention, roll characteristics are improved by increasing camber change characteristics, and riding comfort is also obtained by decreasing a thread change.

According to the above-stated rear wheel suspension system, the shock absorber and the spring are separated, the link point between the lower fixing eye of the shock absorber and the carrier is positioned to be lower than the link point between the transverse lower arm and the carrier, and an upper mount strut of the shock absorber is connected to the side portion of the frame instead of being connected to a wheel house. Therefore, the rear wheel suspension becomes compact, and the rear wheel suspension apparatus can be prevented from protruding into the rear seat of a vehicle so that a wide passenger room space and a wide trunk space can be secured.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A rear wheel suspension apparatus for a vehicle, comprising:
a carrier to which a wheel is mounted;
a plurality of arms comprising a transverse lower arm connecting the carrier to a sub-frame, a transverse compensating arm, a transverse upper arm, and a longitudinal arm;
a spring providing an elastic force; and
a shock absorber, wherein the transverse upper arm is positioned ahead of the transverse lower arm, the spring is located on the transverse lower arm, a lower fixing eye of the shock absorber is connected to the carrier at a position lower than a link point between the carrier and the transverse lower arm, and an upper portion of the shock absorber is connected to a side portion of a vehicle frame.

2. The apparatus of claim 1, wherein the upper portion of the shock absorber is connected to a slanted portion of a side portion of the vehicle frame, and wherein the lower fixing eye is connected to a lower portion of the carrier.

3. The rear wheel suspension apparatus of claim 2, wherein the lower fixing eye is positioned to be lower by more than 25 mm than the link point between the carrier and the transverse lower arm.

4. The apparatus of claim 1, wherein a first end of the longitudinal arm is connected to the carrier and a second end of the longitudinal arm is rotatably connected to a vehicle body.

5. The apparatus of claim 1 further comprising a stabilizer elongating in a front portion of the sub-frame, wherein the stabilizer is fixed to the sub-frame through a guide and both ends of the stabilizer are connected to the carrier.

6. The apparatus of claim 1 further comprising a stabilizer elongating in a rear portion of the sub-frame, wherein the stabilizer is fixed to the sub-frame through a guide and both ends of the stabilizer are connected to the transverse lower arm.

7. A rear wheel suspension apparatus for a vehicle, comprising:
a carrier to which a wheel is mounted;
a plurality of arms comprising a transverse lower arm connecting the carrier to a sub-frame, a transverse compensating arm, a transverse upper arm, and a longitudinal arm;
a spring providing an elastic force; and
a shock absorber, wherein the transverse upper arm is positioned according to a ratio of two distances.

8. The apparatus of claim 7, wherein the a ratio of a first distance between inner and outer link points of the transverse lower arm, and a second distance between a center point between an inner link point of the transverse upper arm and an inner link point of the transverse compensating arm and a center point between an outer link point of the transverse upper arm and an outer link point of the transverse compensating arm is determined to be approximately between 0.55 and 0.65.

9. The apparatus of claim 7, wherein the ratio of a first distance between a center point of the carrier and a center point between the outer link point of the transverse lower arm and the outer link point of the transverse compensating arm, and a second distance between the center point of the carrier and the outer link point of the transverse upper arm is determined to be approximately between 0.9 and 1.1.

10. The apparatus of claim 7, wherein the ratio of a first distance between a center point between the outer link point of the transverse lower arm and the outer link point of the transverse compensating arm and a center point between the inner link point of the transverse lower arm and the inner link point of the transverse compensating arm, and a second distance between the outer and inner link points of the transverse upper arm is determined to be approximately between 0.7 and 0.9.

11. The apparatus of claim 8, wherein the outer link point of the transverse lower arm is positioned longitudinally ahead of the inner link point of the transverse lower arm or longitudinally at the same level with the inner link point of the transverse lower arm.

12. The apparatus of claim 8, wherein the outer link point of the transverse compensating arm is positioned longitudinally behind the inner link point of the transverse compensating arm or longitudinally at the same level with the inner link point of the transverse compensating arm.

13. The apparatus of claim 9, wherein the outer link point of the transverse lower arm is positioned not to be higher than the inner link point of the transverse lower arm and wherein the outer link point of the transverse compensating arm is positioned not to be higher than the inner link point of the transverse compensating arm.

14. The apparatus of claim 10, wherein the outer link point of the transverse lower arm is positioned not to be higher than the inner link point of the transverse lower arm and wherein the outer link point of the transverse compensating arm is positioned not to be higher than the inner link point of the transverse compensating arm.

15. The apparatus of claim 7, wherein one end of the longitudinal arm is fixed to the carrier, and the other end of the longitudinal arm is rotatably connected to a vehicle body.

16. The apparatus of claim 7, further comprising a stabilizer elongating in a front portion of the sub-frame, wherein the stabilizer is fixed to the sub-frame through a guide, and both ends of the stabilizer are connected to the carrier.

17. The apparatus of claim 7, further comprising a stabilizer elongating in a rear portion of the sub-frame, wherein the stabilizer is fixed to the sub-frame through a guide, and both ends of the stabilizer are connected to the transverse lower arm.
